(19) United States
(12) Patent Application Publication
(10) Pub. No.: US 2009/0132660 A1
(43) Pub. Date: May 21, 2009

(54) NETWORK CHAT DEVICE AND METHODS THEREOF

(75) Inventor: Patrick J. Wyatt, Bellevue, WA (US)

Correspondence Address: LARSON NEWMAN ABEL & POLANSKY, LLP, 5914 WEST COURTYARD DRIVE, SUITE 200, AUSTIN, TX, 78730, US

(73) Assignee: ARENANET, INC., Bellevue, WA (US)

(21) Appl. No.: 11/941,264

(22) Filed: Nov. 16, 2007

(51) Int. Cl. G06F 15/82; G06F 3/00

(52) U.S. Cl. 709/206; 715/758

(57) ABSTRACT

A server device can receive availability inquiries from chat programs via a network. The server device determines a first user's availability to a second user based on whether that second user is a member of one of a set of groups identified by the first user. Based on the determination, the server device communicates information indicating the first user's availability to a chat program which displays an indicator, such as an icon, based on the information. Accordingly, a user can identify his availability to other users on a group-by-group basis, providing a flexible way for a user to target his interactions via the chat program to a limited group of users.

### FIELD OF THE DISCLOSURE

The present disclosure relates to computer programs and more particularly to chat programs.

### BACKGROUND

The growth of wide area networks such as the Internet has increased the number of available options for people to communicate with each other. One such option is a chat program, which allows users of the program at different computers to conduct a “chat”, including a text-based, voice, or video communication, via a wide area network. The chat program provides a convenient and flexible way for program users to communicate. However, because the users of the chat program are typically located in different places, it can be difficult to determine when a user is available to communicate via the chat program. Accordingly, an improved chat program would be useful.

### BRIEF DESCRIPTION OF THE DRAWINGS

The present disclosure may be better understood, and its numerous features and advantages made apparent to those skilled in the art by referencing the accompanying drawings.

FIG. 1 illustrates a block diagram of a particular embodiment of a communication network in accordance with one embodiment of the present disclosure;

FIG. 2 is a block diagram of a particular embodiment of user availability information of FIG. 1;

FIG. 3 is a block diagram of a particular embodiment of a graphical user interface for a chat program of FIG. 1;

FIG. 4 is a block diagram of a particular embodiment of an alternative embodiment of the graphical user interface for the chat program of FIG. 1; and

FIG. 5 is a block diagram of a particular embodiment of a graphical user interface for an options window of the chat program of FIG. 1;

FIG. 6 is a flow diagram of a particular embodiment of a method of determining availability information; and

FIG. 7 is a block diagram of a particular embodiment of a computer device corresponding to a client device or server device of FIG. 1.

The use of the same reference symbols in different drawings indicates similar or identical items.

### DETAILED DESCRIPTION

A server device can receive availability inquiries from chat programs via a network. The server device determines a first user's availability to a second user based on whether that second user is a member of one of a set of groups identified by the first user. Based on the determination, the server device communicates information indicating the first user's availability to a chat program which displays an indicator, such as an icon, based on the information. Accordingly, a user can identify his availability to other users on a group-by-group basis, providing a flexible way for a user to target his interactions via the chat program to a limited group of users.

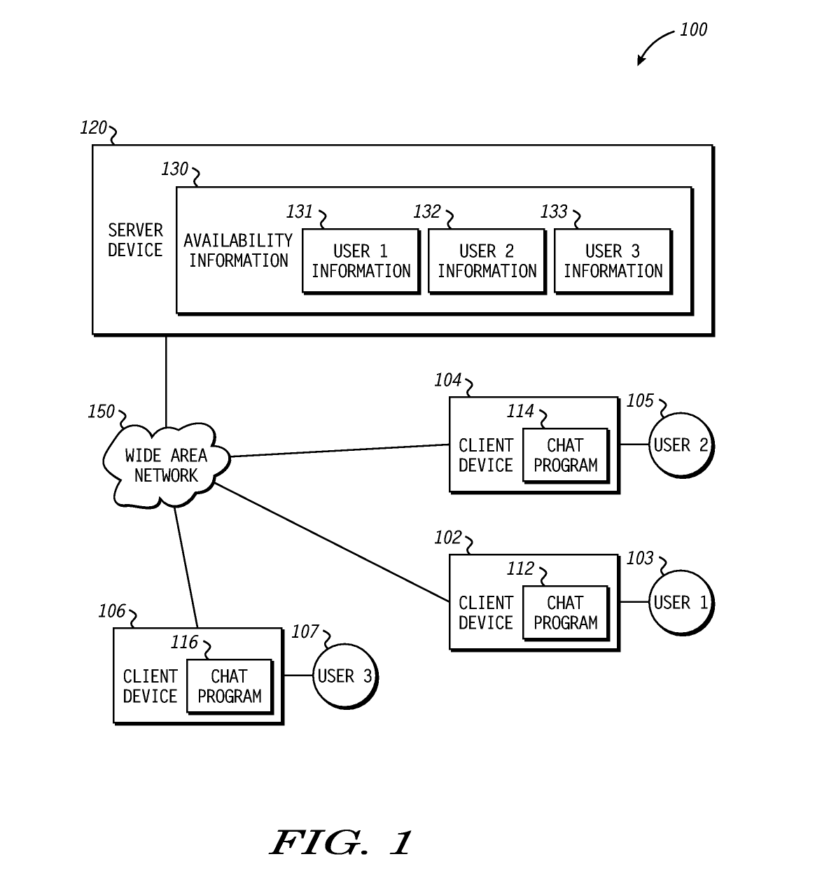

Referring to FIG. 1, a block diagram of a particular embodiment of a communication network 100 is illustrated. The communication network 100 includes a wide area network 150 connected to a server device 120 and client devices 102, 104, and 106.

The wide area network 150 provides a backbone for communications between devices connected to the network. In an embodiment, the wide area network 150 is a packet-switched network that includes gateways, routers, servers, and other communication devices to route packets from source devices to destination devices. To illustrate, the wide area network 150 can route packets between any of the client devices 102, 104, and 106 and the server device 120. In an embodiment, the wide area network 150 is the Internet. Further, the wide area network 150 can be a wireless network, a wired network, or a combination thereof.

The server device 120 is a computer device that is configured to perform services for client devices connected to the wide area network 150. Such services can include email services, storage and file services, security and authentication services, and the like. In an embodiment, the server device 120 is a game server that executes a network game program to allow one or more client devices to participate in an online game.

The client devices 102, 104, and 106 are devices configured to execute tasks according to instructions embodied in a computer program. The instructions manipulate a processor to control one or more components of the client device 102, 104, or 106. To illustrate, the client device 102 can execute a computer program, such as a web browser, to connect to the wide area network 150. The client devices 102, 104, and 106 can be personal computers, mobile or cellular telephones, personal data assistants, and the like.

Each of the client devices 102, 104, and 106 executes a chat program. In particular, the client device 102 executes a chat program 112, the client device 104 executes a chat program 114, and the client device 116 executes a chat program 116. Each of the chat programs 112, 114, and 116 allows a user to communicate with another user of a chat program. The chat programs 112, 114, and 116 can provide for a number of modes of communication, such as text, voice, video, and the like, or a combination thereof.

In operation, each of the chat programs 112, 114, and 116 can be associated with a user of the program. In an embodiment, a user becomes associated with one of the chat programs 112, 144, or 116 by entering authentication information, such as a user identification and password, to the program. In the illustrated embodiment of FIG. 1, a user 103, labeled User1, is associated with the chat program 112, a user 105, labeled User2, is associated with the chat program 114, and a user 107, labeled user 107, is associated with the chat program 116.

In response to a user associating herself with a chat program, the program determines which users are available for communication. To illustrate, the server device 120 includes availability information 130 for each user of a chat program, including availability information 131, associated with User1, availability information 132, associated with User2, and availability information 133, associated with User3. In response to User1 associating himself with the chat program 116 (e.g. by logging in to the chat program), the program sends a communication to the server device 120. In response, the server device 120 determines the set of users for whom User1 desires availability information. In an embodiment, this determination is based on a list of users associated with User1 (not shown) stored at server device 120.

For each user for whom User1 requests availability information, the server 120 accesses the availability information 130 associated with the user. This can be illustrated with an example. In this example, User1 logs into the chat program 112, which notifies the server 120 of the login. In response, the server 120 determines that User1 desires availability information for User2 and User3. Accordingly, the server 120 accesses the availability information 132 and 133 to determine the availability of User2 and User3, respectively.

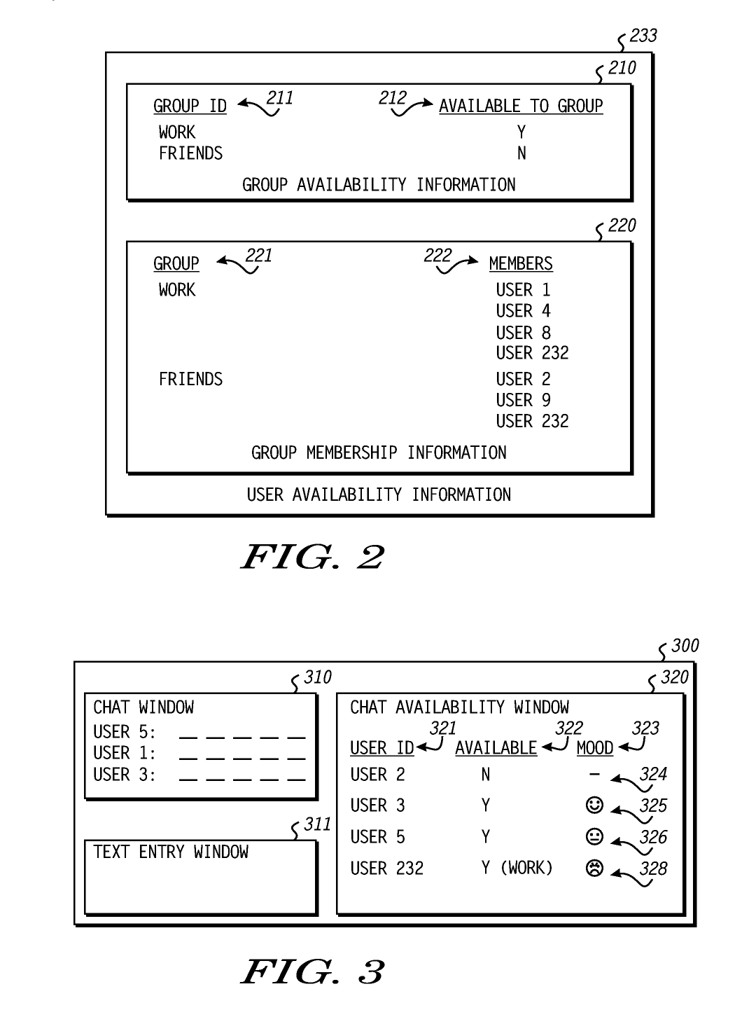

The availability information 130 indicates whether a user is available for communication, and can also indicate other information, such as a user-programmed mood. The server 120 provides this availability information to the requesting chat program for display. This allows a user of the program to quickly determine which users are available for communication. In the illustrated embodiment of FIG. 1, the availability information 130 can be stored and displayed according to groups of users. This can be better understood with reference to FIG. 2.

FIG. 2 illustrates a particular embodiment of user availability information 233, corresponding to user availability information 133 of FIG. 1. The user availability information 233 can be stored at the server 120 in a database, as a set of XML data, and the like. The user availability information 233 includes group availability information 210 and group membership information 220. The group membership information 220 includes information indicating which users are members of a particular group, while the group availability information 210 includes information indicating whether a user is available for communication to members of a particular group.

In particular, the group availability information 210 includes group identification information 211, which identifies a group, and availability information 212, which indicates whether the user is available for communication to users in that group. Thus, in the illustrated example of FIG. 1, User3 is available to communicate with members of the group “Work”, but is not available to communicate with members of the group “Friends.”

The group membership information includes group identification information 221, which identifies a group, and membership information 222, which identifies the members of the associated group. Accordingly, in the illustrated example of FIG. 2, the group Work includes the members User1, User4, User8, and User232, while the group Friends includes the members User2, User9, and User232.

Referring again to FIG. 1, in response to User3 entering login information to the chat program 116, information is sent to the server device 120 indicating that User3 has logged in. In response, the server device 120 accesses the availability information 133 associated with User3 and determines, based on this information, that User3 is not available to chat with User2 and is available to chat with User 1. In particular, the server device 120 determines that User3 is available to chat with members of the Work group, as illustrated in FIG. 2, but is not available to chat with members of the Friends group, and further determines which users are associated with each group.

After determining whether User3 is available to chat with a particular user, the server device 120 determines whether the user is logged in to a chat program and, if so, notifies the user of User3's availability. For example, after determining that User3 is not available to chat with User2, the server 120 determines that User2 is associated with chat program 114, and therefore sends a notification to the client device 104 that User3 is unavailable. The chat program 114 receives the notification and displays an indication of User3's unavailability. This can be better understood with reference to FIG. 3.

FIG. 3 illustrates a particular embodiment of a graphical user interface (GUI) 300 for a chat program, such as the chat program 112 of FIG. 1. The GUI 300 includes a chat window 310, a text entry window 311, and a chat availability window 320.

The chat window 310 is configured to display text information reflecting communications between chat program users. In the illustrated embodiment of FIG. 3, the GUI 300 is associated with the chat program 112, associated with User1, who is conducting a chat with another user, labeled User5. Accordingly, as the client device 102 receives communications via the wide area network 150 from the chat program associated with User5, the communications are displayed in the chat window 310.

The text entry window 311 is configured to receive text information entered by a user associated with the chat program. Accordingly, in the illustrated example of FIG. 3, User1 can select the text entry window 311 with a computer mouse or other device and enter text via a keyboard or other device. Upon selection of a particular key, the chat program 116 transmits the entered text via the wide area network 150 to chat programs associated with the users participating in the chat (e.g. User5). In an embodiment, the text is communicated via the server device 120. In another embodiment, the text is communicated in a peer-to-peer (P2P) fashion. In addition, the entered text can be displayed in the chat window 310, so that the window displays both transmitted and received communications in a transcript fashion.

The chat availability window 320 is configured to display availability information for other chat program users. In an embodiment, the chat program associated with the GUI 300 accesses a stored list of users for whom availability information should be displayed. For example, in the illustrated embodiment of FIG. 3, the chat program 112 can access a stored file indicating a list of favored users identified by User1 and can display availability information for users indicated by the list in the chat availability window 320.

The chat availability window includes user identification information 321, availability information 322, and mood information 323. The user identification information 321 indicates a chat program user, the availability information 322 indicates whether the associated user is available for communication, and the mood information 323 displays a mood icon indicating a user selectable mood for an associated user. The mood information 323 can be based on mood information stored at the availability information 130. Further, the mood information stored at the availability information 130 can be set to indicate different moods for different user groups in similar fashion to the availability information as described with respect to FIG. 2. Thus, a user can set mood information to be displayed for a particular group of users.

In the illustrated example of FIG. 3, the chat availability window displays availability information for four users. Row 324 displays availability information for User2, and indicates that the user is unavailable for communication. Further, because User2 is unavailable, no mood icon is displayed. In another embodiment, mood information can be displayed even for users that are unavailable for communication.

Row 325 displays availability information for User3, and indicates that the user is available for communication and has selected a “happy” mood icon to be displayed. This indicates that User3 would welcome a communication from User1. Row 326 displays availability information for User5, and indicates that the user is available for communication and has selected an “indifferent” icon to be displayed. This can indicate to User1 that User5 is available only for important communications.

Row 328 displays availability information for User232, and indicates that the user is available to chat for members of his “Work” group. Accordingly, as illustrated, the availability information can indicate for which group a user is available to chat. This can be useful if a target user is associated with more than one of a user's groups, and the target user is available for communication with only a subset of those groups. This can be useful to indicate that a user is available for communication, but only with regard to particular topics. As further illustrated in row 328, User232 has selected an “angry” mood icon for display as mood information. This can indicate to User1 that User232 is available only for emergency communications.

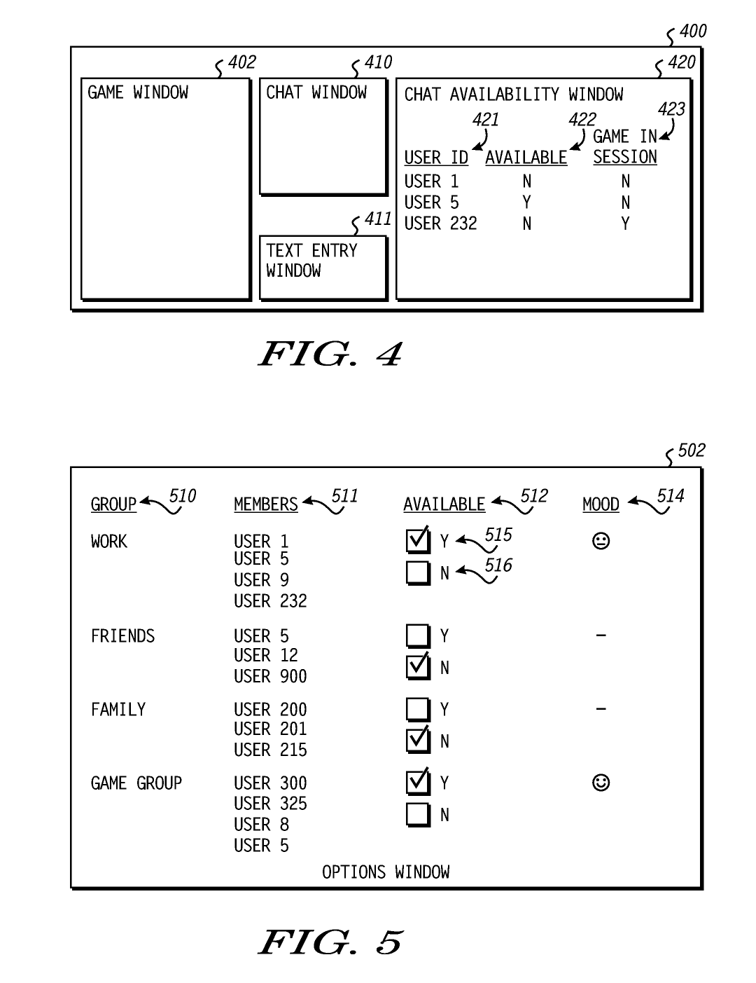

Referring to FIG. 4, a diagram of a particular embodiment of a graphical user interface 400 associated with a chat program is illustrated. In the illustrated embodiment of FIG. 4, the chat program is integrated with an online game program. Accordingly, the graphical user interface includes a game window 402, which is configured to display game information, such as a graphical display of a game world, game characters, and the like, to provide the online gaming experience to the user.

The GUI 400 also includes a chat window 410 and a text entry window 411. These windows are configured to operate in similar fashion to the chat window 310 and text entry window 311 discussed with respect to FIG. 3. The chat window 410 and text entry window 411 allow a player of a game in the game window 402 to interact and communicate with other game players. In addition, the chat window 410 and text entry window 411 can provide for interaction with users that are not participating in a game.

The GUI 400 further includes a chat availability window 420 to display user identification information 420, availability information 422, and game session information 423. The user identification information 420 displays information identifying users of the chat program associated with the GUI 400. The availability information 422 indicates whether a user is available for communication. The session information 423 indicates whether a user is participating in a session of the game displayed via the game window 402. The session information 423 can be stored at the availability information 130 and can indicate different session information for different user groups in similar fashion to the availability information as described with respect to FIG. 2. Thus, a user can set session information to be displayed for a particular group of users.

Referring to FIG. 5, a diagram of a particular embodiment of an options window 502 for a chat program is illustrated. In an embodiment, the options window 502 can be displayed via a graphical user interface, such as the GUI 300 of FIG. 1. The options window 502 is configured to allow a user to place other chat program users into groups, and to configure availability and mood information for each group.

The options window 510 includes a group field 510, a members field 511, an availability field 512, and a mood field 514. The group field 510 indicates the name of a group identified by the chat program user. This information can be derived from a set of pre-selected options available at the chat program, or can be customized by the user.

The members field 511 indicates the users associated with a group indicated in the group field 510. Accordingly, in the illustrated embodiment of FIG. 5, the users User1, User5, User9, and User232 are associated with the group “Work.” The members field 511 can be configured by a user to add or subtract members from each group. The configuration can be done in a “drag-and-drop” fashion, via text entry of user identification information, and the like.

The availability field 512 includes availability options for each group identified in the group field 510. For example, in the illustrated example of FIG. 5, the group Work is associated with an “available” option 515 and an “unavailable” option 516. By selecting the appropriate option, the user indicates whether she is available for communication to members of the associated group. Accordingly, in the illustrated embodiment of FIG. 5, the user is available for communication to members of the Work group and the Game group, but not to members of the Family group and the Friends group.

The mood field 514 includes mood information for each group identified in the group filed 510. The mood information can be selected by entry of text (e.g. “emoticons” or phases: “busy”, “waiting for a phone call”, etc.), via a pull-down menu (e.g. to select animated graphics, videos, sound/musical theme), by using voice commands, and the like. The mood information can be displayed as an icon, text or a video stream, indicated via an audio stream, and the like.

In operation, the chat program determines group and availability information based on options entered by the user via the options window 502, and sends this information to the server device 120 for storage at the availability information 130. Accordingly, by changing the information displayed via the options window 502, a user changes the availability information 130, and thereby changes the availability information displayed to members of each group identified in the group field 510.

Further, the availability information 130 can be altered based on predetermined or programmable criteria. For example, a user can configure the availability information for each group indicated in the group field 510 to be set according to a time value. For example, a user could configure the availability information 130 to indicate that the user is not available to members of a Friends group during particular times of day (e.g. from 8:00 a.m.-5:00) or during particular days. This automation of the setting the availability information can provide additional convenience to a user.

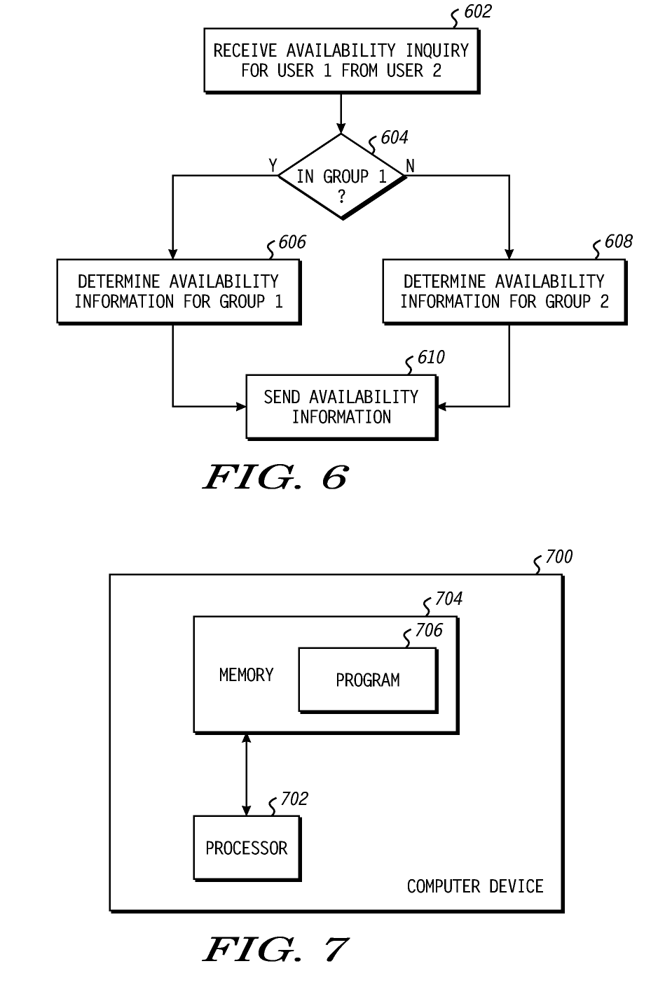

Referring to FIG. 6, a flow diagram of a particular embodiment of a method of determining availability information for a chat program user is illustrated. At block 602, an availability inquiry for a user, identified in the illustrated example as User1, is received at a server from a chat program associated with another user, identified in the illustrated example as User2. At block 604, the server accesses availability information associated with User2, and determines whether User2 is associated with a first group, labeled Group 1, or a second group, labeled Group2. Accordingly, in the illustrated example of FIG. 6, User1 has configured his availability information so that users are in one of two possible groups. It will be appreciated that in other embodiments the availability information can be configured so that more groups are available, and that a user can be associated with multiple groups.

If at block 604, it is determined that User2 is associated with Group1, the method flow proceeds to block 606 and the server determines availability information for Group1. The availability information can indicate whether User1 is available to communicate with members of the group, mood information, availability to participate in a game session, and the like. Moving to block 610, the availability information is sent to the chat program associated with User2, where it is displayed.

Returning to block 604, if it is determined that User2 is not associated with Group1, the method flow moves to block 608 and the server determines availability information for Group2. The method flow proceeds to block 610, and the availability information is sent to the chat program associated with User2 for display.

FIG. 7 shows a block diagram of a particular embodiment of a computer device 700. The computer device 700 can correspond to a client device or server device of FIG. 1, or both. The computer device 700 includes a processor 702, a memory 704. The computer device 700 can include additional hardware, such as a network interface (not shown) to interface with the wide area network 150, a display device (not shown) to display the GUI 300 and 400 of FIGS. 3 and 4, and the like.

The memory 704 is a computer readable medium, and can be volatile memory, such as random access memory (RAM), or non-volatile memory, such as flash memory or a hard disk. The memory 704 stores a program 706 that includes instructions to manipulate the processor 702 in order to implement one or more of the methods described herein.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method comprising:
determining at a server device if a first user is a member of a first group based on group information associated with a second user;
determining a first availability characteristic of the first group in response to determining the first user is a member of the first group; and
communicating the first availability characteristic to a chat program associated with the first user, the first availability characteristic indicating whether the second user is available for communication via the chat program.

2. The method of claim 1, further comprising:
determining if the first user is a member of a second group based on group information associated with a third user;
determining a second availability characteristic for the second group in response to determining the first user is a member of the second group, the second availability characteristic different from the first; and
communicating the second availability characteristic to the chat program associated with the first user.

3. The method of claim 1, wherein the first availability characteristic indicates mood information, and wherein the first availability characteristic indicates a mood indicator associated with the mood information.

4. The method of claim 3, wherein the mood indicator is selected from the group consisting of: a mood icon, mood text, graphic stream, and audio stream.

5. The method of claim 1, wherein the chat program is integrated with a game program.

6. The method of claim 1, wherein the first availability characteristic indicates whether the second user is participating in a game session associated with a game program.

7. The method of claim 1, wherein the first availability characteristic is based upon a time value.

8. The method of claim 7, wherein the time value indicates a time of day.

9. The method of claim 1, wherein communicating the first availability characteristic comprises communicating an identifier indicating the first group.

10. A method, comprising:
receiving from a first chat program a first request for availability information, the first request comprising user identification information for a first user;
determining first availability information for a first group of users in response to determining based on the user identification information that the first user is a member of a first group of users; and
sending the first availability information to the first chat program.

11. The method of claim 10, further comprising:
receiving from a second chat program a second request for availability information, the second request comprising the user identification information for the first user;
determining second availability information for a second group of users in response to determining based on the user identification information that the first user is a member of a second group of users; and
sending the second availability information to the second chat program.

12. The method of claim 11, wherein the second availability information is different from the first.

13. The method of claim 12, wherein the first availability information indicates the first user is available, and the second availability information indicates the first user is not available.

14. The method of claim 11, wherein the first availability information includes first mood information and the second availability information includes second mood information.

15. The method of claim 14, wherein the first mood information is different from the second.

16. The method of claim 10, wherein the first availability information indicates whether the first user is available for a game session associated with an online game.

17. A computer readable medium storing a program comprising instructions configured manipulate a processor to perform a method comprising:
determining if a first user is a member of a first group based on group information associated with a second user;
determining a first availability characteristic of the first group in response to determining the first user is a member of the first group; and
communicating the first availability characteristic to a chat program associated with the first user, the first availability characteristic indicating whether the second user is available for communication via the chat program.

18. The computer readable medium of claim 17, wherein the method further comprises:
determining if the first user is a member of a second group based on group information associated with a third user;
determining a second availability characteristic for the second group in response to determining the first user is a member of the second group, the second availability characteristic different from the first; and
communicating the second availability characteristic to the chat program associated with the first user.

19. The computer readable medium of claim 17, wherein the first availability characteristic indicates mood information, and wherein the first availability characteristic indicates a mood indicator associated with the mood information.

20. The computer readable medium of claim 19, wherein the mood indicator is selected from the group consisting of: a mood icon, mood text, graphic stream, and audio stream.

21. The computer readable medium of claim 17, wherein the chat program is integrated with a game program.

22. The computer readable medium of claim 17, wherein the first availability characteristic indicates whether the second user is participating in a game session associated with a game program.

23. The computer readable medium of claim 17, wherein the first availability characteristic is based upon a time value.

24. The computer readable medium of claim 23, wherein the time value indicates a time of day.
